(19) United States
(12) Patent Application Publication
(10) Pub. No.: US 2003/0119554 A1
(43) Pub. Date: Jun. 26, 2003

(54) Method and arrangement for performing a cashless payment transaction

(76) Inventor: Michael Horn, Munchen (DE)

Correspondence Address: Kevin R. Spivak, Morrison & Foerster LLP, Suite 300, 1650 Tysons Boulevard, McLean, VA, 22102, US

(21) Appl. No.: 10/293,931

(22) Filed: Nov. 14, 2002

(30) Foreign Application Priority Data
Nov. 15, 2001 (DE) 10156177.6

(51) Int. Cl. H04B 1/38; H04M 1/00; H04M 11/00

(52) U.S. Cl. 455/558; 455/556; 455/409; 455/407; 455/408

(57) ABSTRACT

Method for performing a cashless payment transaction using a trader station, a mobile radio terminal belonging to a user and having a SIM card which is provided with an identifying identifier, and a central station which is connected to the mobile radio terminal and to the trader station over a data network. A first electronic credit value for cashlessly paying for a telephony service is assigned to a first account and is stored in a first credit memory, and a second electronic credit value for cashlessly paying for goods or a service is assigned to a second account and is stored in a second credit memory, the first and the second account being combined in a user interface as a joint account.

### CLAIM FOR PRIORITY

This application claims priority to Application No. 10156177.6 which was filed in the German language on Nov. 15, 2001.

### TECHNICAL FIELD OF THE INVENTION

The invention relates to a system and method for performing a cashless payment transaction.

### BACKGROUND OF THE INVENTION

Cashless payment transactions are being performed to an increasing degree. Reasons for this include, for example, that purchasers do not always carry large sums of money with them in order to be able to make larger purchases. This reduces the risk of theft, and allows spontaneous purchases to be made. In addition, the vendor does not need to handle large sums of money.

In the past, credit cards were introduced for this reason. Credit cards allow the cardholder to make a cashless payment using a valid credit card and signature, or even just using the number on the credit card. However, the risk of misuse is high since credit cards can easily be stolen and can be used without authorization when the signature has been forged.

On account of the high transaction charges which are incurred with credit cards, one alternative which has been developed is smart cards with an integrated processor memory unit. These smart cards use encryption technology in order to sums of money on the cards such that the card can be loaded using authorized institutions. To pay larger sums, a PIN is provided which is checked directly by the smart card upon payment. However, this type of payment requires a dense network of loading stations in order to overcome the acceptance threshold. In addition, the traders need to provide corresponding reading stations.

Cashless payments using a mobile radio terminal are therefore penetrating the market to an increasing degree. This method involves a sum of money for goods purchased by a purchaser being read in on a trader station, for example using a cash register system connected to the trader station, or being input directly using an input device on the trader station. This sum is transmitted, together with an identifier for the trader station, to a central station, where the data are buffer-stored. The payer uses a mobile radio terminal to send the trader station's identifier to the central station, which compares the identifier with that in the stored data and transmits the appropriate sum of money to the mobile radio terminal. There, confirmation of the payment is requested and is transmitted to the central station, which transmits a corresponding entry to an account-managing facility, for example a credit institute, with which the payer holds an account. This method therefore requires a mobile radio terminal, a trader station and a central station which is connected to the mobile radio terminal and to the trader station via telecommunications and/or data links.

This type of cashless payment can be made in mobile fashion at a wide variety of locations, including at vending machines or in taxis, inter alia. In contrast to the use of credit cards, the temporary mobile radio telephone link and the input of confirmation during this time mean that the trader is not able to use data interchanged during the link for later transactions. In addition, the involvement of the central station allows the payment to be made without security-related data associated with the purchaser, such as the identifier, being passed to the trader. This ensures anonymous payment.

In addition, purchasers who already have a mobile radio terminal can implement this form of payment very easily and inexpensively. This is a particular advantage because mobile telephones are already widespread, which means that a large circle of users can use this system without further investment. This method is also suitable for handling very small sums.

Cashless payment using a mobile radio terminal is not dependent on the type of mobile radio agreement. This means that users who have a mobile radio terminal which is managed via a prepaid account can also make cashless payments to a trader. The traders can be either virtual (that is to say an operator of an e-shop) or operators of real shops.

On the mobile radio market today, approximately one third of all mobile radio customers worldwide already have a “prepaid account”, that is to say an account into which money is paid in advance and can then be used to make mobile telephone calls. In some countries, the percentage of new agreements which are prepaid agreements is 80%, and sometimes more.

These prepaid accounts, called prepaid telephony accounts (PTAs) below, are not suitable for mobile payment for goods purchased from a trader unless there is serious conversion. The reason for this is that the processes are presently implemented with a mobile network operator (MNO) such that, when a PTA is loaded, the full value-added tax for the loaded sum is actually paid at the time of loading. This method was chosen because the redeemed sum is regarded as a type of credit voucher for telephony services (voice transmission, universal number services, premium rate services, etc.) provided solely by the MNO itself. This avoided a complex method, namely the separate payment of value-added tax for every single service provided, be it just a few pence for a short telephone call. However, cashless payment using a mobile radio terminal is intended to allow payment for goods from traders, however. The PTA up to now therefore cannot be used for this purpose without modifications.

If the money for paying for goods from a trader is debited from a PTA, the prepaid value-added tax for this sum needs to be reimbursed for the payment by the financial authority. This is because no telephony service has been provided for the sum of money, and the corresponding part of the prepaid value-added tax has been overpaid. This practice has the advantage that the PTAs to date can continue to be used. However, it is a drawback that reimbursement of the value-added tax is very complex and difficult to control.

One alternative involves introducing a new account type, called mobile payment account (MPA) below, to replace the PTA. This account is managed on a gross basis, i.e. no value-added tax at all is paid from this account, but rather all sums are paid gross. Payment of the value-added tax is then the responsibility of the trader, who needs to pay the value-added tax, in line with the rate of value-added tax which applies to the goods, on the gross sum to the financial authority upon receipt of payment.

The MPA would be used not just for cashless payment for goods using a mobile radio terminal, but rather all telephony services which have been routed via the PTA to date could also be paid for using this account. In this case, the PTA would thus be replaced by the MPA, which would result in a change in the MNO's processes. This change would have to involve the value-added tax for the loaded sums now no longer being paid directly when the prepaid account is loaded, but rather when the service is provided. The advantage of this method is that the user has one account to manage, as previously.

However, a drawback is that this entails a high level of conversion of the MNO's processes. Another drawback is that the MNO cannot ensure that the user generates a minimum revenue for telephony services, since the user can, of course, also use the entire sum in the MPA to pay for goods from traders.

### SUMMARY OF THE INVENTION

The invention provides a method for simple, secure and transparent cashless payment for goods and services using a mobile telephone, and an arrangement for carrying out the method.

According to one embodiment of the invention, a first electronic credit value for the cashless payment transaction for a telephony service is assigned to a first account and is stored in a first memory, and a second electronic credit value for the cashless payment transaction for goods and/or a service is assigned to a second account and is stored in a second memory, the first and the second account being combined as a joint account for the user. The first account (PTA) for paying for a telephony service is subject to value-added tax. The second account is to be managed on a gross basis, i.e. no value-added tax is paid from this account. It is used merely to pay for goods and/or services.

The first and second accounts are combined, with the combined electronic credit value being assigned to a joint account and being stored, in particular, in a transaction data memory. This involves the two accounts being linked by means of an intelligent method such that the user sees the joint account—that is to say an “account total”. The user is thus given a clear overview of his electronic credit value, which increases the acceptance of this method.

In another embodiment, the electronic credit value stored in the first memory is loaded with an electronic credit value stored in the second memory using an account transfer function. This ensures that the first account includes sufficient credit to pay for the telephony service. However, the user need not concern himself with reloading the first account, since the account transfer function automatically reloads the first account with an electronic credit value from the second account.

In still another embodiment, the account transfer function comprises the following:

a) a lower and an upper account threshold value for an electronic credit value in the first account are set for paying for the telephony service,

b) a signal is given when the electronic credit value falls below the lower account threshold value for the first account as a result of use of the telephony service,

c) a reload function is triggered when the electronic credit value falls below the lower account threshold value, and

d) the first account is loaded up to the upper account threshold value with an electronic credit value from the second account.

When a credit value is debited from the first account as a result of use of a telephony service, no value-added tax is paid. When the credit value in the first account reaches or falls below the lower account threshold value the first account is reloaded. Value-added tax corresponding to the reloaded credit value is not paid until the reloading of the electronic credit value from the second account to the first account. This has the advantage that the value-added tax is always paid in tranches in line with the reloaded credit value.

Preferably, the method is carried out such that the first account limitation is followed by performance of the following:

d1) a decimation function is triggered when the first account is loaded with the loading credit value from the second account,

d2) the electronic credit value in the second account is decimated by the loading credit value.

In another embodiment of the invention, a reload function for the joint account is offered in response to the sum of the two credit values (i.e. the account balance in the joint account) falling below the upper account threshold value for the first account, by virtue of the user being informed about the account balance and his being instructed to top up the account again at his credit institute. This ensures that there is a sufficiently large residual sum available for using the telephony service. It is thus certain that the user cannot spend all of his credit on one purchase, which would result in a telephone call in progress being abruptly terminated following payment. The user is notified of the need to reload the second account by means of a graphical indication on the display of the mobile radio terminal and/or by means of an audible warning indicator, for example.

In another preferred embodiment of the invention, the central station has a processor device which is connected to a user checking device and to a trader checking device for requesting authorization for a trader and for a user.

The central station preferably also has an account transfer device, connected to the first credit memory, to the second credit memory and to the transaction data memory, for implementing a reload function for the first account.

The credit values in the two accounts are assigned to a joint account using a suitable management device. The credit value in the joint account is stored in the transaction data memory, which is connected to the account transfer device.

### BRIEF DESCRIPTION OF THE DRAWINGS

Preferred embodiments of the invention are described below with reference to the drawings, in which

FIG. 1 shows a system for cashless payment using a mobile radio terminal in accordance with the prior art.

FIG. 2 shows a debit operation for telephony services.

FIG. 3 shows debiting of a sum for paying for goods and/or services.

FIG. 4 shows an electronic credit value in a joint account.

FIG. 5 shows a central station.

### DETAILED DESCRIPTION OF THE PREFERRED EMBODIMENT

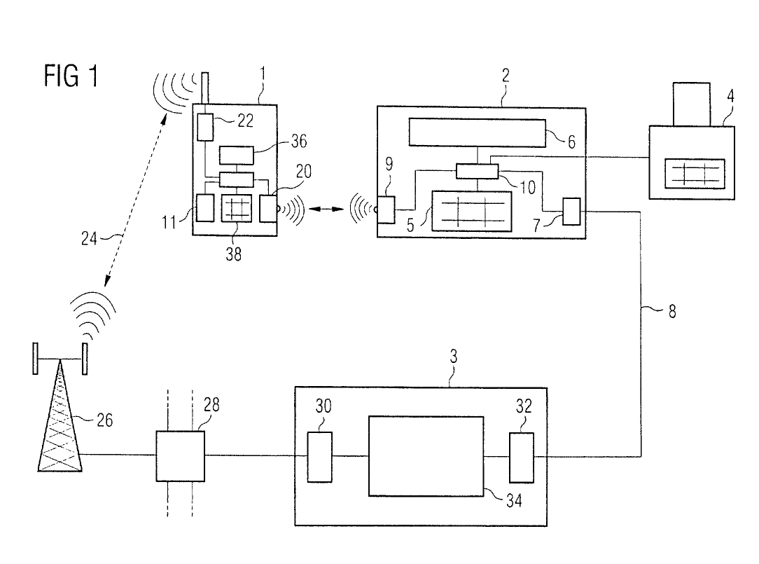

FIG. 1 shows a system for cashless payment using a mobile radio terminal 1 (of conventional basic design). The figure shows the mobile radio terminal 1, a trader station 2 and a central station 3, which are temporarily connected to one another.

The central station 3 is connected to the mobile radio terminal 1 via a mobile radio link and to the trader station 2 via a data link. The three devices—mobile radio terminal 1, trader station 2 and central station 3 —each have identifying identifiers which are, by way of example, the telephone numbers of the mobile radio terminal 1, of the trader station 2 and of the central station 3. Instead of the telephone numbers, other identifiers, for example IP addresses, can also be used, however.

If a purchaser wishes to pay for goods and/or a service with an electronic credit value, then the sum for the goods and/or service is first read into the trader station 2. This is done, by way of example, by virtue of the sum first being input into an electronic cash register system 4 which is connected to the trader station 2. The sum is then transferred to the trader station 2. Preferably, the sum can also be read into the trader station 2 directly using a trader station input device 5, for example a keypad or a scanner. The sum is displayed on a first output device 6. (At this juncture, it will be pointed out that the term “trader station” denotes part of the equipment provided by the system operator. This is thus not the property of the trader, and the trader also has no access to the customer's data which are input thereon and processed therein.)

The sum is then transferred to the central station 3 using a first transmission/reception device 7. In addition to the sum, an identifier for the mobile radio terminal 1 is transmitted to the central station 3, as described further below. Preferably, this information is transmitted over a data link 8. The data link 8 can also be any suitable type of telecommunications link.

The trader station 2 also has a second transmission/reception device 9 for receiving the identifier for the mobile radio terminal 1. This can be, for example, an infrared interface or a Bluetooth module. The first and second transmission/reception devices 7, 9 and the input and output devices 5, 6 are connected to a first processor device 10.

The mobile radio terminal 1 has an inherently known SIM card 11 which is activated by inputting a PIN. This SIM card 11 is used to generate the identifier for the mobile radio terminal 1. In addition, the mobile radio terminal 1 has, for interchanging data, a third transmission/reception device 20, which is again formed by the aforementioned infrared interface or the Bluetooth module, for example. The interchanged data are in this case the identifier for the mobile radio terminal 1. In addition, it is also possible to transmit the identifier for the trader station 2 to the mobile radio terminal 1, and/or information about the sum of money to be paid. The mobile radio terminal 1 additionally transmits its identifier to a GSM base station 26 via a radio interface 24 using a fourth transmission/reception device 22. The identifier is then—e.g. upon request by the central station—transmitted to the central station 3 via a switching station 28.

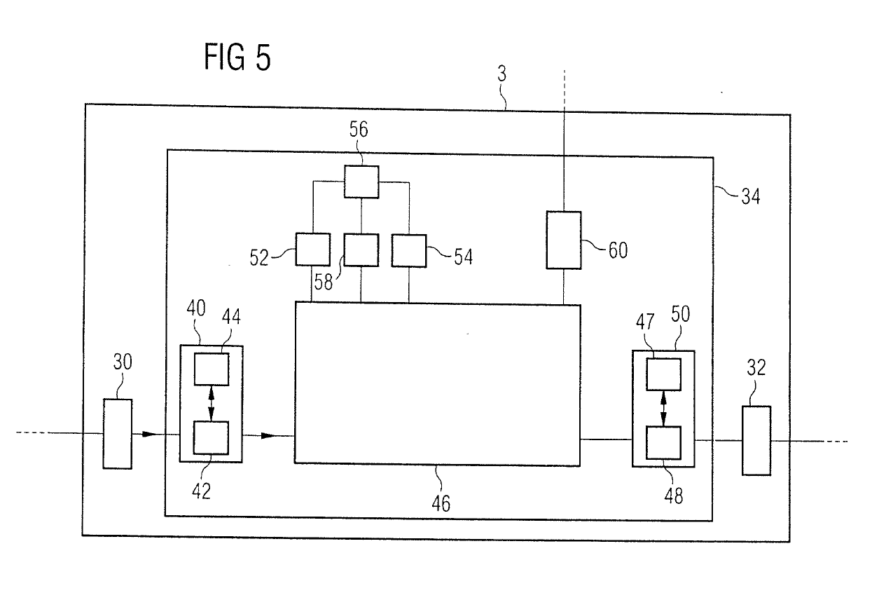

The central station 3 has a fifth transmission/reception device 30 for setting up a connection to the switching station 28 and a sixth transmission/reception device 32 for setting up a connection to the trader station 2. In addition, the central station 3 has a logging device 34 connected to the transmission/reception devices 30, 32, which is explained in more detail in FIG. 5.

The logging device 34 transmits the sum received from the trader station 2 back to the mobile radio terminal 1 via the radio interface 24. A second output device 36 on the mobile radio terminal 1 displays this sum. The user is then asked to transmit confirmation information to the central station 3 if the sum shown is correct. This can be done, by way of example, by pressing a particular key on a second input device 38 on the mobile radio terminal 1. When the confirmation information is received at the central station 3, the sum is then debited from an account belonging to the user. The debit operation is explained in more detail in the description relating to FIG. 5.

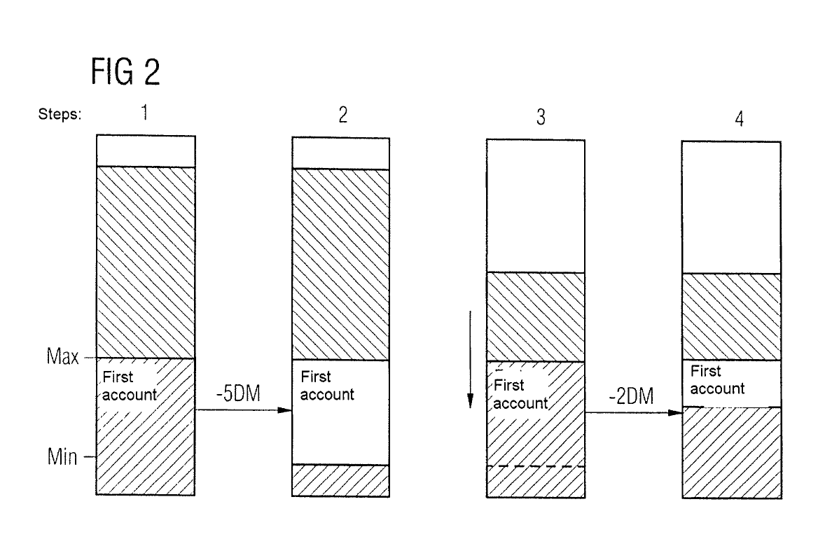

FIG. 2 shows a debit operation for a telephone service, having a value of DM 7, for example, in accordance with the present invention. The first account is assigned two threshold values: an upper threshold value (Max) and a lower threshold value (Min). In this embodiment, the upper threshold value is DM 6 and the minimum one is DM 1, for example. If the credit value falls below a lower threshold value during use of a telephone service, then the first account is automatically topped up from the second account, up to the upper threshold value. In this example, the first account is thus topped up from the second account with DM 5. If the residual sum in the second account is less than DM 5, then the first account is topped up with this residual sum. This step of account transfer from the first account to the second account requires payment of value-added tax. The residual sum of DM 2 is debited from the first account as previously.

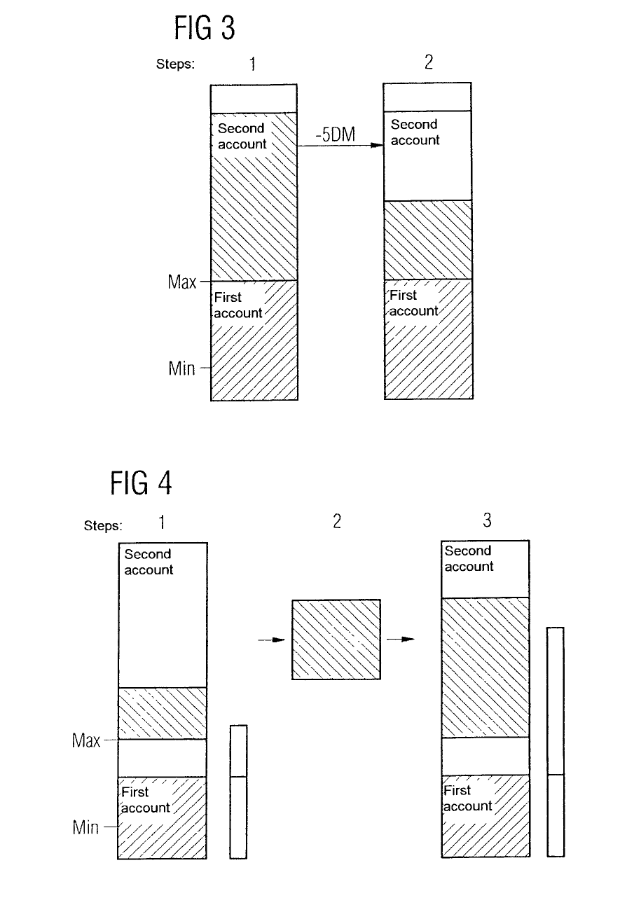

Overall, the entire credit value—that is to say the sum of the first account and the second account—can be spent for telephony services. Upon transfer between the first account and the second account, the value-added tax is paid as previously when loading the first account. In this example, the value-added tax is thus debited in respected tranches of DM 5 each. The MTO is thus not required to change the method of paying value-added tax. FIG. 3 shows a debit operation for an electronic credit sum for paying for goods and/or services. If the user wishes to pay for goods and/or services without cash, then he merely has the credit value in the second account available for this purpose. The maximum he can spend on goods and services is thus the value of the indicated credit minus the upper threshold value for the first account. In this example, a sum of DM 5 is debited from the second account. This step involves no value-added tax being paid—the value-added tax is paid later by the trader.

FIG. 4 shows an electronic credit value being displayed on the mobile terminal. This display of credit can be shown, by way of example, on a display on the mobile terminal 1. In this embodiment, the first account is loaded with an electronic credit value of DM 4 and the second account is loaded with a sum of DM 3. The narrow column shown next to the schematic illustration indicates the sum of the credit value in both accounts on the display. In this example, the column indicates a residual credit value of DM 7. In 2, the second credit value is loaded with an electronic credit value of DM 6. In 3, it is possible to see that the second account now holds a sum of DM 9, while the first account still stores a sum of DM 4. The narrow column shown next to 3 indicates the credit value after loading. The user now sees very quickly that the joint account holds a loaded sum of DM 13, with DM 4 being available for telephony services and DM 9 being available for paying for goods and/or services.

FIG. 5 shows the design of the central station 3. The central station's logging device 34 includes a user checking device 40, which includes a user comparator 42 and a user data memory 44 connected thereto. The user comparator 42 is connected to the fifth transmission/reception device 30, which is connected to a public data network, for example a telephone network. The user's identifier received by the transmission/reception device 30 is compared in the user comparator 42 with user identifiers which are stored in the user data memory 44. If the user identifier matches one of the user identifiers stored in the user data memory 44, the user identifier is transmitted to a second processor device 46 provided in the logging device 34. Otherwise, the connection is interrupted.

In parallel with this identity check, the trader identifier is checked. The trader identifier is received by the sixth transmission/reception device 32 and is transmitted to a trader comparator 48 in a trader checking device 47. The trader comparator 48 checks the trader identifier using the trader identifiers stored in a trader data memory 50. If the trader identifier matches one of the trader identifiers stored in the trader data memory 50, the trader identifier and the sum transmitted by the trader station 2 are transmitted to the second processor device 46 provided in the logging device 34. Otherwise, the connection is interrupted.

The processor device 46 is connected to a first memory 52 and to a second memory 54. This gives the second processor device 46 access to a first account stored in the first memory 52 and to a second account 54 stored in the second memory. A sum to be paid as a result of use of a telephony service is debited from the first account using the second processor device 46. The sum stored in the first memory 52 is decimated accordingly. The goods purchased at the trader station 2 are paid for by debiting a sum from the second account. As soon as the user's confirmation information about the sum to be paid is received, the second processor device 46 is used to decimate the second account's credit stored in the second memory 54 by the sum to be paid.

The central station also has an account transfer device 56. This device is connected to the first and second memories 52, 54. When the credit value in the first account falls below a lower account threshold value, the first account is loaded from the second account using a reload function implemented in the account transfer device 56. According to the transferred sum, value-added tax is then paid. In addition, in a request routine, the sum stored in the first memory 52 and in the second memory 54 is added up regularly using the account transfer device 56, and the added sum is stored in a transaction data memory 58. This memory is connected to the second processor device 46.

In addition, the central station has a seventh transmission/reception device 60, connected to the second processor device 46, for setting up a connection to at least one credit institute. When the second account falls below the upper account threshold value, the seventh transmission/reception device 60 is used to set up a connection to the mobile radio terminal 1 and to transmit a message about the account balance to the user. At the same time, the user is provided with the option (preferably likewise directly using the mobile telephone 1) of sending an instruction to the credit institute, which will transfer a sum to the second account.

At this juncture, it will be pointed out that all the method steps described above are claimed to be fundamental to the invention independently and in any combination, particularly the details shown in the figures. A person skilled in the art is familiar with modifications thereto.

What is claimed is:

1. A method for performing a cashless payment transaction using a trader station, a mobile radio terminal belonging to a user and having a SIM card which is provided with an identifying identifier, and a central station which is connected to the mobile radio terminal and to the trader station over a data network, comprising:
assigning a first electronic credit value for cashlessly paying for a telephony service to a first account, which is stored in a first credit memory; and
assigning a second electronic credit value for cashlessly paying for goods or a service to a second account, which is stored in a second credit memory,
the first and the second account being combined in a user interface as a joint account.

2. The method as claimed in claim 1, wherein the first electronic credit value, stored in the first memory, is loaded from the second electronic credit value, stored in the second memory, using an account transfer function.

3. The method as claimed in claim 2, further comprising:
setting a lower and an upper account threshold value for the electronic credit value in the first account;
providing a signal when the electronic credit value falls below the lower account threshold value for the first account as a result of use of the telephony service;
triggering a reload function when the electronic credit value falls below the lower account threshold value; and
loading the first account up to the upper account threshold value with an electronic credit value from the second account.

4. The method as claimed in claim 3, wherein the loading further comprises:
triggering a decimation function is triggered when the first account is loaded with the loading credit value from the second account; and
decimating the second electronic credit value in the second account by the loading credit value.

5. The method as claimed in claim 3, further comprising:
sending a notification to the user when the sum of the first and second electronic credit values falls below the upper threshold value for the first account.

6. A system for performing cashless payment, comprising:
a first credit memory to store a first electronic credit value;
a second credit memory to store a second electronic credit value; and
a credit management device to jointly manage the first and second electronic credit values, said credit management device providing a user interface to display the two credit values as a joint account.

7. The system as claimed in claim 6, wherein the credit management device comprises:
a transaction data memory to store a sum comprising the first and second electronic credit values as the account balance in the joint account; and
an account transfer device, connected to the first memory, to the second memory, and to the transaction data memory, to implement a reload function in the first account.

8. The arrangement as claimed in claim 6, wherein the account management device comprises a user checking device, a trader checking device and a processing device, connected thereto, to provide an authentication check for a user and a trader, and to control a debit operation in response to a positive result for the authentication check.

9. The arrangement as claimed in claim 7, wherein the account management device comprises a user checking device, a trader checking device and a processing device, connected thereto, to provide an authentication check for a user and a trader, and to control a debit operation in response to a positive result for the authentication check.
